(19) United States
(12) Patent Application Publication
(10) Pub. No.: US 2018/0034183 A1
(43) Pub. Date: Feb. 1, 2018

(54) ELECTRICAL CONNECTOR WITH INTEGRATED ANTI-DECOUPLING FEATURES

(71) Applicant: TYCO ELECTRONICS CORPORATION, Berwyn, PA (US)

(72) Inventors: Inho Myong, Newark, CA (US); Nicholas John Swatko, Bedford, MA (US)

(21) Appl. No.: 15/220,523

(22) Filed: Jul. 27, 2016

(51) Int. Cl. H01R 13/426

(52) U.S. Cl. CPC H01R 13/426

(57) ABSTRACT

Electrical connector includes a connector shell having a passage therethrough and an end section. The electrical connector also includes a coupling nut that is mounted to the end section of the connector shell and has a sleeve wall that surrounds and interfaces with the end section. The coupling nut is rotatable about a central axis. One of the sleeve wall of the coupling nut and the connector shell is shaped to include a spring arm, and the other includes a series of radial teeth that are disposed circumferentially around the central axis. The spring arm slidably engages the radial teeth in a ratchet-like manner as the coupling nut is rotated about the central axis. The spring arm and the radial teeth impede rotation in a first direction about the central axis and permit rotation in an opposite second direction about the central axis.

### BACKGROUND

The subject matter herein relates generally to electrical connectors that use coupling nuts and have features that prevent inadvertent decoupling of the mating connector.

One known type of electrical connector includes a backshell having a passage therethrough that receives a plurality of cables (e.g., insulated wires). The electrical connector also includes a coupling nut that is rotatably mounted to an end of the connector shell. The coupling nut has internal or external threads that engage the end of the connector shell. The coupling nut is also configured to engage a mating connector and thereby connect the electrical connector and the mating connector. One example of the above electrical connector is an AS85049 connector. Other types of connectors exist that may utilize a coupling nut.

For certain applications, such as those that experience a substantial amount of shock and/or vibrations (e.g., military aircraft), the electrical connector includes an anti-decoupling mechanism that resists rotation of the coupling nut in a decoupling direction. For example, the electrical connector may include one or more retaining rings, spring clips, or spring fingers that engage the coupling nut and the backshell in a manner that impedes rotation of the coupling nut in the decoupling direction. These elements are typically small, metallic elements that are positioned between the coupling nut and the backshell. Although these elements can work effectively by impeding rotation in the decoupling direction, certain drawbacks may exist. For example, it can be challenging to position the elements between the coupling nut and the backshell.

Accordingly, there is a need for an electrical connector that includes an anti-decoupling feature that is simpler and/or more cost effective than the decoupling mechanisms of known electrical connectors.

### BRIEF DESCRIPTION

In an embodiment, an electrical connector is provided that includes a connector shell having a passage therethrough configured to support an electrical pathway. The connector shell also includes an end section. A central axis extends through a center of the passage. The electrical connector also includes a coupling nut that is mounted to the end section of the connector shell and has a sleeve wall that surrounds and interfaces with the end section. The coupling nut is rotatable about the central axis. One of the sleeve wall of the coupling nut and the connector shell is shaped to include a spring arm, and the other includes a series of radial teeth that are disposed circumferentially around the central axis. The spring arm slidably engages the radial teeth in a ratchet-like manner as the coupling nut is rotated about the central axis. The spring arm and the radial teeth impede rotation in a first direction about the central axis and permit rotation in an opposite second direction about the central axis.

In an embodiment, an electrical connector is provided that includes a connector shell having a passage therethrough configured to support an electrical pathway. A central axis extends through a center of the passage. The connector shell has an end section that includes a series of radial teeth disposed circumferentially around the central axis. The radial teeth face radially away from the central axis. The electrical connector also includes a coupling nut that is rotatably mounted to the end section of the connector shell. The coupling nut has a sleeve wall that surrounds and interfaces with the end section of the connector shell. The sleeve wall is shaped to include a spring arm. The spring arm slidably engages the radial teeth in a ratchet-like manner as the coupling nut is rotated about the central axis. The spring arm and the radial teeth impede rotation in a first direction and permit rotation in an opposite second direction.

In an embodiment, an electrical connector is provided that includes a connector shell having a passage therethrough configured to support an electrical pathway. A central axis extends through a center of the passage. The connector shell has an end section that is shaped to include a spring arm. The electrical connector also includes a coupling nut that is rotatably mounted to the end section of the connector shell. The coupling nut has a sleeve wall that surrounds and interfaces with the end section of the connector shell. The sleeve wall is shaped to include a series of radial teeth disposed circumferentially around the central axis. The radial teeth face radially toward the central axis. The spring arm slidably engages the radial teeth in a ratchet-like manner as the coupling nut is rotated about the central axis. The spring arm and the radial teeth impede rotation in a first direction and permit rotation in an opposite second direction.

Optionally, one or more embodiments may be devoid of discrete elements that are disposed between the coupling nut and the connector shell. Optionally, one or more embodiments may be devoid of discrete elements that are disposed between the coupling nut and the connector shell, except for sealing members, such as o-rings.

### BRIEF DESCRIPTION OF THE DRAWINGS

FIG. 1 is a partially exploded view of an electrical connector in accordance with an embodiment that includes a connector shell and a coupling nut that is configured to rotatably engage the connector shell.

FIG. 2 is a perspective view of the electrical connector of FIG. 1 when assembled.

FIG. 3 is a rear perspective view of the coupling nut that may be used with the electrical connector of FIG. 1.

FIG. 4 is a perspective sectional view of the electrical connector of FIG. 1 illustrating an interaction between the connector shell and the coupling nut.

FIG. 5 is a cross-section of the electrical connector of FIG. 1 illustrating a spring arm of the coupling nut engaged with radial teeth of the connector shell.

FIG. 6 is a front perspective view of a coupling nut in accordance with an embodiment.

FIG. 7 is a rear perspective view of the coupling nut of FIG. 6.

FIG. 8 is an exploded view of a multi-piece connector shell in accordance with an embodiment that includes an intermediate component.

FIG. 9 is an enlarged perspective view of the intermediate component of FIG. 8.

FIG. 10 is an enlarged perspective view of the multi-piece connector shell of FIG. 8.

FIG. 11 is a perspective sectional view of an electrical connector in accordance with an embodiment that includes the multi-piece connector shell of FIG. 8.

FIG. 12 is a perspective sectional view of the electrical connector of FIG. 11 illustrating a spring arm engaged with radial teeth of the connector shell.

FIG. 13 is an exploded view of an electrical connector in accordance with an embodiment.

### DETAILED DESCRIPTION

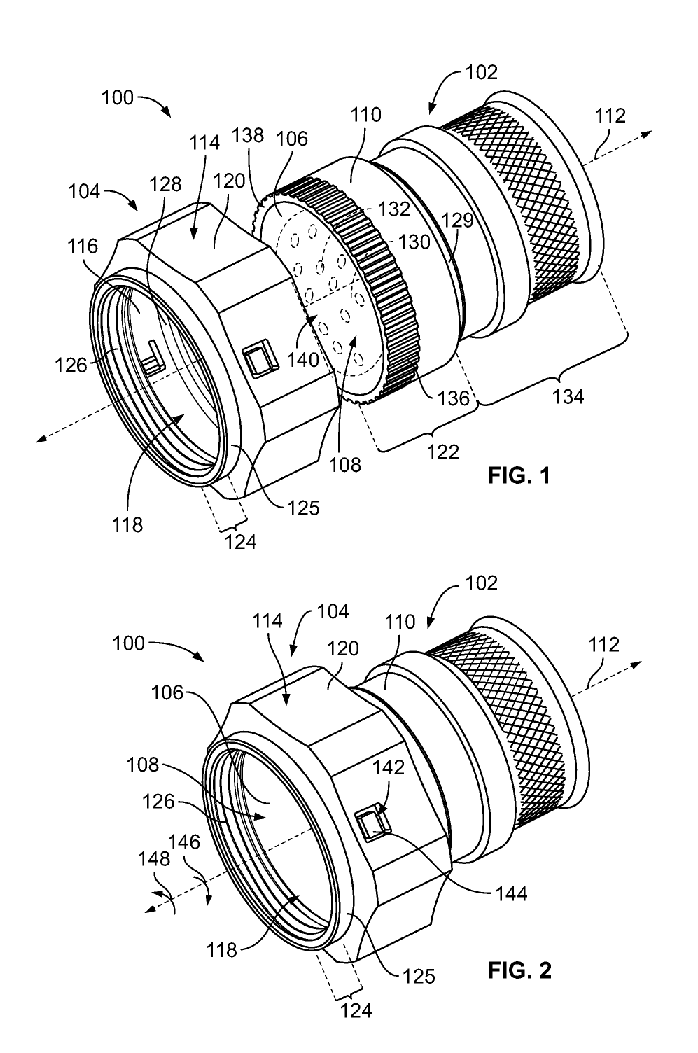

FIG. 1 is a partially exploded view of an electrical connector 100 having a connector shell 102 and a coupling nut 104 that is configured to rotatably engage the connector shell 102. In FIG. 1, the coupling nut 104 is spaced apart from the connector shell 102, but poised for engaging the connector shell 102. When fully assembled as shown in FIG. 2, the electrical connector 100 is configured to engage a mating connector (not shown) in which the coupling nut 104 securely couples the electrical connector 100 and the mating connector in a mated engagement. In some embodiments, the connector shell 102 may be referred to as a backshell.

The connector shell 102 may comprise a conductive material that surrounds an electrical pathway extending through a passage 108 of the connector shell 102. The connector shell 102 may electrically engage a corresponding shell or housing (not shown) of the mating connector to establish a continuous shield along the electrical pathway. The electrical connector 100 may be configured to satisfy various governmental and industry standards or specifications. In some embodiments, the electrical connector 100 may be referred to as a circular connector.

As shown in FIG. 1, the connector shell 102 has an inner surface 106 that defines the passage 108 and an outer surface 110 that defines an exterior of the connector shell 102. A central axis (or centerline) 112 extends through a center (e.g., geometric center) of the passage 108. A forward portion of the central axis 112 is linear as shown in FIG. 1, but other portions of the central axis 112 may not be linear based upon the shape of the connector shell 102. For example, the connector shell 102 may be a right-angle shell. The coupling nut 104 and the connector shell 102 are aligned with each other along the central axis 112.

The coupling nut 104 includes a sleeve wall 114 that has an inner surface 116 (FIG. 1) defining a coupling cavity 118. The sleeve wall 114 also has an outer surface 120 that defines an exterior of the coupling nut 104. The coupling cavity 118 is sized and shaped to receive an end section 122 (FIG. 1) of the connector shell 102. The coupling nut 104 also includes a front mating section 124 that is coupled to the sleeve wall 114. The front mating section 124 includes a section wall 125 that extends in a forward direction that is parallel to the central axis 112 and circumferentially extends around the central axis 112. The section wall 125 has threads 126 that extend around the central axis 112. In the illustrated embodiment, the threads 126 are internal threads that face radially-inward toward the central axis 112, but it is contemplated that other embodiments may include external threads that face radially-outward.

Also shown, the sleeve wall 114 includes a retaining member 128 along the inner surface 116. The retaining member 128 extends around the central axis 112 and projects radially inwardly toward the central axis 112. The retaining member 128 is configured to rotatably secure the coupling nut 104 to the end section 122 of the connector shell 102. For example, the retaining member 128 may directly engage a sloped surface 129 of the end section 122. As such, the coupling nut 104 may resist being inadvertently withdrawn in a direction away from the connector shell 102.

The passage 108 is configured to support an electrical pathway. For example, in some embodiments, the electrical pathway includes a plurality cables or insulated wires (e.g., a bundle of insulated wires) that extend through the passage 108 and are electrically terminated to a mating connector. In other embodiments, however, the electrical connector 100 may include a dielectric insert 130 (indicated in phantom) that is positioned in the passage 108 of the connector shell 102. The dielectric insert 130 may shaped to define a gap or space between the dielectric insert 130 and the inner surface 106. Alternatively, the dielectric insert 130 may be molded to complement the interior space of the passage 108 and engage the inner surface 106.

The dielectric insert 130 is configured to hold one or more communication pathways that constitute the electrical pathway of the electrical connector 100. For example, the dielectric insert 130 may hold electrical contacts 132 (also indicated in phantom) that are configured to electrically engage corresponding contacts (not shown) of the mating connector. The electrical contacts 132 may be positioned within and extend through the dielectric insert 130. The electrical contacts 132 may be socket contacts that are configured to receive corresponding contact pins (not shown) of the mating connector. Alternatively, the electrical contacts 132 may be contact pins that are received by corresponding socket contacts of the mating connector. It should be understood, however, that various other types of electrical contacts may be supported by the dielectric insert 130.

The connector shell 102 also includes a base section 134. The base section 134 may be sized and shaped to engage other components (not shown) and receive one or more wires or cables (not shown). For example, the base section 134 may be shaped to provide strain relief or may be coupled to other components that provide strain relief. The end section 122 is positioned in front of the base section 134 and is configured to engage the coupling nut 104. In the illustrated embodiment, the base section 134 and the end section 122 are portions of a unitary element. For example, the base section 134 and the end section 122 may be formed from the same mold. In other embodiments, the base section 134 and the end section 122 may be discrete components that are coupled to each other.

As shown in FIG. 1, the end section 122 of the connector shell 102 has a leading edge 138 that extends around the central axis 112 and defines an opening 140 to the passage 108. The end section 122 includes a plurality of radial teeth 136 along the outer surface 110 that are disposed circumferentially around the central axis 112. In the illustrated embodiment, the radial teeth 136 face radially away from the central axis 112. The radial teeth 136 are positioned immediately adjacent to the leading edge 138 or include the leading edge 138. In other embodiments, the radial teeth 136 may have a different location relative to the central axis 112 such that the radial teeth 136 are spaced apart from the leading edge 138. In some embodiments, the leading edge 138 of the connector shell 102 has an outer diameter and the front mating section 124 of the coupling nut 104 has an inner diameter that is less than the outer diameter of the leading edge 138.

Turning to FIG. 2, the sleeve wall 114 of the coupling nut 104 surrounds and interfaces with the end section 122 of the connector shell 102. The sleeve wall 114 is shaped to include a spring arm 144 that engages the end section 122. For example, the sleeve wall 114 includes a wall opening 142. In the illustrated embodiment, the wall opening 142 extends entirely through the sleeve wall 114 between the inner and outer surfaces 106, 120. In other embodiments, however, the wall opening 142 may be a recess that extends only partially into the sleeve wall 114. For example, the wall opening 142 may extend a depth into the sleeve wall 144 from the inner surface 106.

The spring arm 144 is a resulting structure of the sleeve wall 114 that is defined by the surrounding wall opening 142. More specifically, the spring arm 144 and at least a portion of the sleeve wall 114 that surrounds and interfaces with the end section 122 of the connector shell 102 are integrally formed. For example, the spring arm 144 and the portion of the sleeve wall 114 may be formed from a common mold or may be 3D printed. In particular embodiments, the coupling nut 104 is a single unitary element that is shaped to include the features shown in FIG. 1, including the spring arm 144 and the sleeve wall 114. As described herein, the spring arm 144 slidably engages the radial teeth 136 (FIG. 1) in a ratchet-like manner as the coupling nut 104 is rotated relative to the connector shell 102 and about the central axis 112.

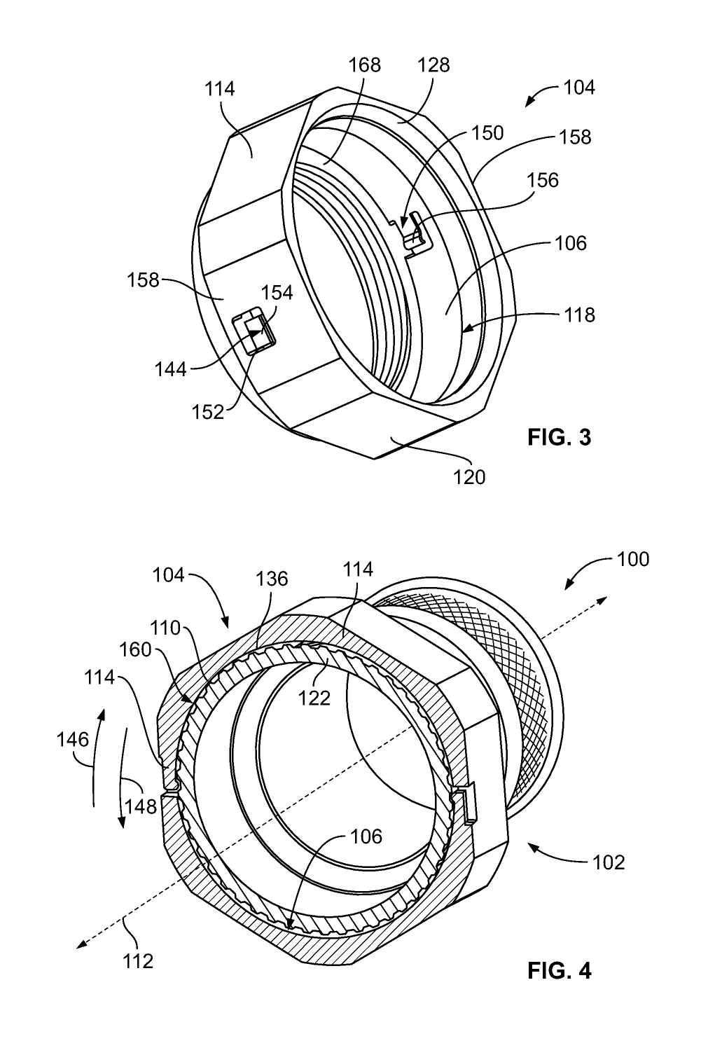

FIG. 3 is a rear perspective view of the coupling nut 104. As shown, the coupling nut 104 includes the spring arm 144 and also includes a spring arm 150. In other embodiments, the coupling nut 104 may include only one spring arm or more than two spring arms. Such an embodiment is shown in FIGS. 6 and 7. The spring arms 144, 150 may be referred to as first and second spring arms 144, 150. Each of the spring arms 144, 150 couples to the remainder of the sleeve wall 114 at a base joint 152 and extends from the base joint 152 along an arm extension 154. The arm extension 154 includes a contoured head 156 that is shaped to engage the radial teeth 136 (FIG. 1). The contoured head 156 is shaped relative to the radial teeth 136 to generate a ratchet-like engagement between the contoured head 156 and the radial teeth 136.

In the illustrated embodiment, the first and second spring arms 144, 150 extend lengthwise in a circumferential direction, which may be similar to the second direction 148 (FIG. 2). But the spring arms 144, 150 may extend in different directions in other embodiments. For example, the spring arms 144, 150 may extend lengthwise in a direction that is parallel to the central axis 112 or in other directions. The contoured head 156 may have a similar shape as described above for the contoured head 156 in the illustrated embodiment and generate a similar ratchet-like engagement with the radial teeth 136.

Also shown, the retaining member 128 may be shaped from material of the sleeve wall 114 such that the retaining member 128 is an integral feature of the sleeve wall 114. In particular, the retaining member 128 of FIG. 3 includes a radially-inward projecting portion of the inner surface 106. The retaining member 128 engages the sloped surface 129 (FIG. 1) such that the coupling nut 104 is prevented from being inadvertently withdrawn when pulled away from the connector shell 102 (FIG. 1) but is permitted to rotate about the central axis 112 (FIG. 1).

In other embodiments, however, the retaining member 128 may be a discrete (or separate) member that is coupled to the inner surface 106. For example, the retaining member 128 may be similar to or identical to an retaining ring or spring. It should be understood, however, that other structural elements exists for coupling the coupling nut 104 to the connector shell 102. For example, a separate coupling nut may be used to rotatably couple the coupling nut 104 to the connector shell 102.

The sleeve wall 114 may form one or more flat or planar surfaces that are shaped, for example, to engage a tool (e.g., wrench). As shown in FIG. 3, the sleeve wall 114 may form multiple wall sections 158. For instance, the sleeve wall 114 includes six (6) wall sections 158 in which each wall section 158 has a planar portion of the outer surface 120. However, the sleeve wall 114 may have other shapes, including a circular shape. Also shown, one of the wall sections 158 includes the spring arm 144 and another wall section 158 includes the spring arm 150. The spring arms 144, 150 oppose each other with the coupling cavity 118 therebetween. The front mating section 124 has a rearward-facing surface 168. The rearward facing surface 168 may function as a blocking surface that engages the leading edge 138 (FIG. 1) of the connector shell 102. More specifically, the rearward facing surface 168 has a diameter that is less than a diameter of the leading edge 138.

FIG. 4 is a perspective sectional view of the electrical connector 100 depicting the coupling nut 104 operably engaged to the connector shell 102. When operably engaged, the coupling nut 104 is mounted to the end section 122 of the connector shell 102 and is rotatable about the central axis 112. An interface 160 is defined between the outer surface 110 of the connector shell 102 and the inner surface 106 of the coupling nut 104.

When operably engaged, the spring arm 144 is slidably engaged to the radial teeth 136 in a ratchet-like manner. More specifically, the spring arm 144 may flex back-and-forth between different positions as the coupling nut 104 is rotated relative to the connector shell 102 and about the central axis 112. The spring arm 144 and the radial teeth 136 impede rotation in a first direction 146 and permit rotation in an opposite second direction 148. As used herein, the phrase “impede rotation in a [designated] direction” means that rotation in the designated direction is either entirely prevented (e.g., the coupling nut is incapable of rotating in the designated direction) or that rotation in the designated direction is resisted more than rotation in the opposite direction. For example, the spring arm 144 and the radial teeth 136 may impede rotation in the first direction 146, but permit rotation in the second direction 148 by requiring at least twice the amount of force to rotate the coupling nut 104 in the first direction 146 than the second direction 148. As another example, the spring arm 144 and the radial teeth 136 may impede rotation in the first direction 146 and permit rotation in the second direction 148 by blocking any rotation in the first direction 146, but permitting rotation in the second direction 148.

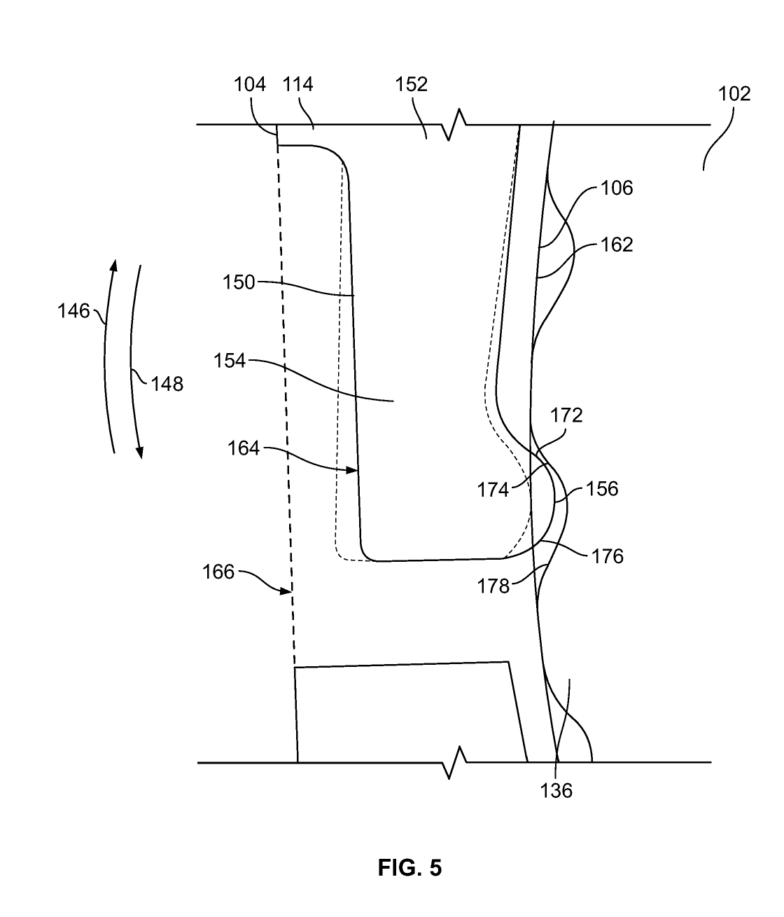

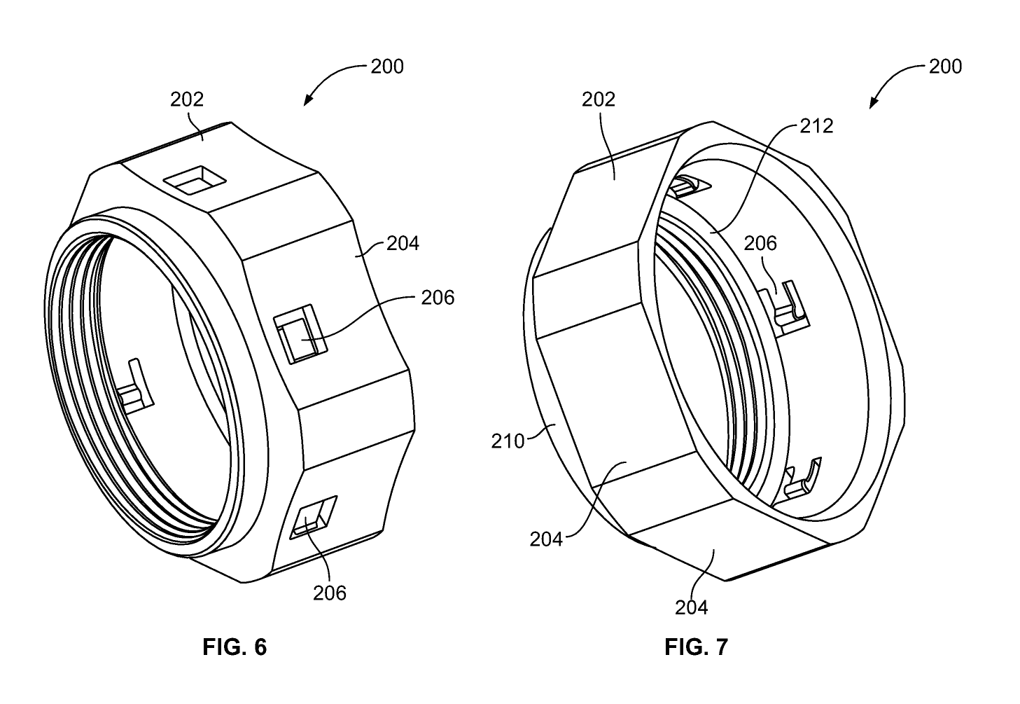

FIG. 5 is a cross-section of the electrical connector 100 illustrating the ratchet-like engagement. As shown in greater detail, the spring arm 150 is coupled to a remainder of the sleeve wall 114 at the base joint 152. The arm extension 154 extends from the base joint 152 to the contoured head 156. In the illustrated embodiment, the contoured head 156 protrudes in a radially-inward direction. The inner surface 106 includes a passage portion 162 that defines nearly an entirety of the coupling cavity 118. The passage portion 162 has a radius of curvature that approximately matches (or is approximately equal to) the radius of curvature of the outer surface 110 of the connector shell 102. As shown, the contoured head 156 is biased to clear the passage portion 162 in a direction toward the radial teeth 136. In some embodiments, at least a portion of the radial teeth 136 may slidably engage (or have nominal gap therebetween) the passage portion 162 of the inner surface 106.

The contoured head 156 is shaped relative to the radial teeth 136 to generate a ratchet-like engagement between the spring arm 150 and the radial teeth 136. The contoured head 156 and the radial teeth 136 may be shaped to provide a mating resistance to the coupling nut 104 when rotated in the first direction 146 that is more than the mating resistance when rotated in the second direction 148. For example, the contoured head 156 and the radial teeth 136 have respective first sides 172, 174 that engage each other and respective second sides 176, 178 that engage each other. The first sides 172, 174 are shaped to impede rotation in the first direction 146, and the second sides 176, 178 are shaped to permit rotation in the second direction 148.

More specifically, a shape or curvature of the first side 172 of the contoured head 156 relative to the shape or the curvature of the first side 174 of the radial teeth may determine the mating resistance for rotating in the first direction 146. Likewise, a shape or curvature of the second side 176 of the contoured head 156 relative to the shape or the curvature of the second side 178 of the radial teeth 136 may determine the mating resistance for rotating in the second direction 148. The mating resistance in the second direction 148 is less than the mating resistance in the first direction 146. As shown, the spring arm 150 has a first position (represented in a solid line in FIG. 5) when the spring arm 150 is undeflected and a second position (represented in a dashed line in FIG. 5) when the spring arm 150 is deflected at its peak.

The sleeve wall 114 has an exterior boundary 166 that is defined by the outer surface 120 of the sleeve wall 114. As shown, the spring arm 150 is positioned within the wall opening 142 such that an outer surface 164 of the spring arm 150 is disposed a depth from the exterior boundary 166 within the wall opening 142. As the spring arm 150 moves between the first and second positions, the spring arm 150 move within the wall opening 142. In the illustrated embodiment, the outer surface 164 does not clear the exterior boundary 166. As such, the spring arm 150 may move freely within the wall opening 142 without being obstructed by external objects, such as a tool that grips the coupling nut 104.

Optionally, the electrical connector 100 may be devoid of discrete elements that are disposed between the coupling nut 104 and the connector shell 102. Optionally, the electrical connector 100 may be devoid of discrete elements that are disposed between the coupling nut 104 and the connector shell 102, except for elastic seal members (e.g., o-rings) that may form a seal between portions of the two.

FIGS. 6 and 7 are front and rear perspectives view of a coupling nut 200 in accordance with an embodiment. The coupling nut 200 is configured to be rotatably mounted to a connector shell (not shown), which may be similar or identical to the connector shell 102 (FIG. 1). The coupling nut 200 may have features that are similar or identical to the features of the coupling nut 104 (FIG. 1). For example, the coupling nut 200 includes a sleeve wall 202 having a plurality of wall sections 204. Unlike the coupling nut 104, however, each of the wall sections 204 has a respective spring arm 206. Each spring arm 206 has an identical shape as the spring arms 144, 150 (FIG. 1), but the spring arm 206 may have other dimensions in other embodiments. Similar to the spring arms 144, 150, the spring arms 206 are configured to slidably engage radial teeth (not shown) when the coupling nut 200 is rotatably mounted to an end section of a connector shell (not shown). Collectively, the spring arms 206 and the radial teeth impede rotation in a first direction and permit rotation in an opposite second direction. Also shown in FIG. 7, a front mating section 210 of the coupling nut 200 may define a rearward-facing surface 212. Similar to the coupling nut 102, the rearward-facing surface 212 is configured to engage a leading edge of the connector shell.

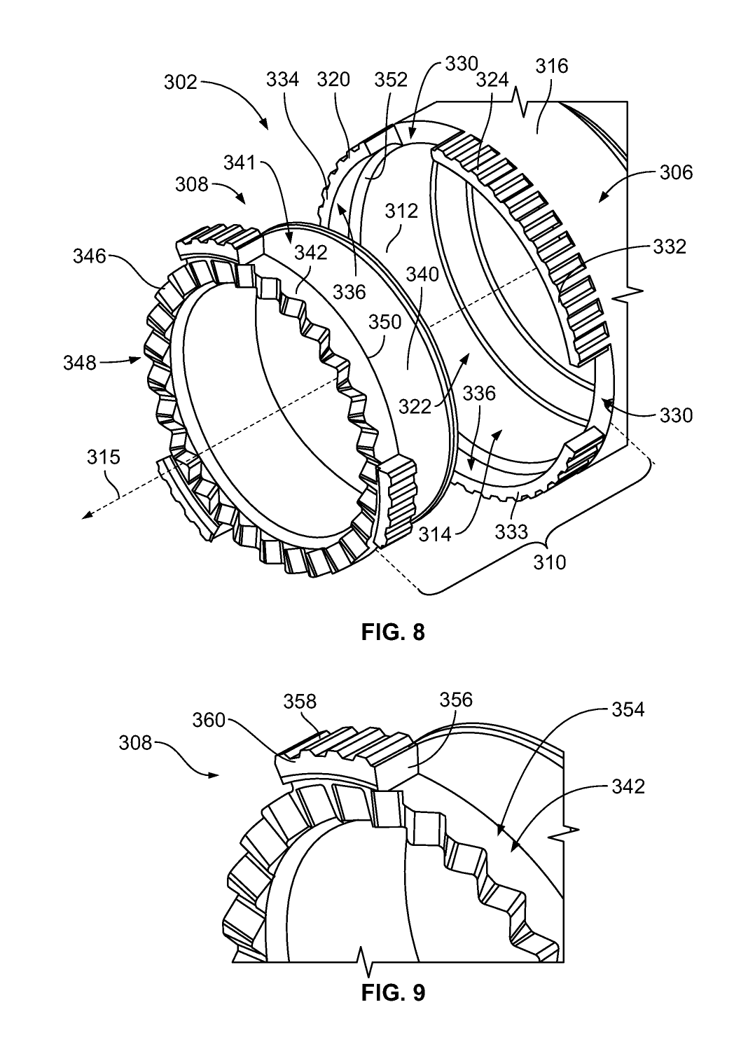

FIG. 8 is an exploded view of a multi-piece connector shell 302 in accordance with an embodiment. The connector shell 302 is configured to form an electrical connector 300 (FIG. 11) when a coupling nut 304 (FIG. 11) is rotatably mounted to the connector shell 302. The coupling nut 304 may be similar or identical to the coupling nut 104 (FIG. 1). The connector shell 302 includes a shell base 306 and an intermediate component 308. When the shell base 306 and the intermediate component 308 are combined, an end section 310 of the connector shell 302 is formed.

As shown, the shell base 306 has an inner surface 312 that defines a passage 314 and an outer surface 316 that defines an exterior of the shell base 306. A central axis (or centerline) 315 extends through a center (e.g., geometric center) of the passage 314. The shell base 306 has a leading edge 320 that defines an opening 322 to the passage 314. The leading edge 320 extends circumferentially about the central axis 315.

The shell base 306 includes radial teeth 324 along the outer surface 316 that are disposed circumferentially around the central axis 315. In the illustrated embodiment, the radial teeth 324 face radially away from the central axis 315. The radial teeth 324 are positioned immediately adjacent to the leading edge 320 or include the leading edge 320. In other embodiments, however, the radial teeth 324 may have a different location such that the radial teeth 324 are spaced apart from the leading edge 320.

As shown, the leading edge 320 of the shell base 306 is shaped to include open-sided slots 330. The open-sided slots 330 open in a forward direction along the central axis 315 and separate different teeth sections 332, 333, 334 of the shell base 306. Each of the teeth sections 332-334 includes a portion of the leading edge 320 and a plurality of the radial teeth 324. Each of the teeth sections 332-334 also includes a corresponding inner surface 336. The inner surfaces 336 are configured to interface with respective portions of the intermediate component 308.

The intermediate component 308 is sized and shaped to be received within a portion of the passage 314. The inner surface 312 may be shaped to complement a structure of the intermediate component 308. For example, the inner surface 312 defines a forward-facing surface 352 that is configured to engage or interface with the intermediate component 308.

The intermediate component 308 has an inner collar 340 and a forward section 342 coupled to the inner collar 340. The forward section 342 includes a leading edge 346 of the intermediate component 308. The forward section 342 has an outer diameter, and the insert collar 340 has an outer diameter. In the illustrated embodiment, the outer diameter of the forward section 342 is greater than the outer diameter of the insert collar 340 such that a rearward-facing surface 350 projects radially away from the insert collar 340. The rearward-facing surface 350 is configured to interface with the forward-facing surface 352 when the intermediate component 308 is positioned within the passage 314. Also shown, the leading edge 346 includes axial teeth 348 that project along the central axis 315 and are configured to engage a mating connector during a mating operation.

FIG. 9 is an enlarged perspective view of a portion of the intermediate component 308. The forward section 342 has an outer surface 354 and radial extensions 356 that are circumferentially distributed about the central axis 315 (FIG. 8) and project radially away from the outer surface 354. Each of the radial extensions 356 is sized and shaped to be positioned within a corresponding open-sided slot 330 (FIG. 8) of the shell base 306 (FIG. 8). Each of the radial extensions 356 includes section teeth (or radial teeth) 358 that face radially away from the central axis 315 and an edge face 360 that faces in a forward direction along the central axis 315 (FIG. 8).

The radial extensions 356, however, are not required. In an alternative embodiment, the intermediate component 308 may include a longitudinal ridge or protrusion (not shown) that extends parallel to the central axis 315 along an outer surface 341 of the inner collar 340. The longitudinal ridge may be sized and shaped to be inserted into a longitudinal channel (not shown) that extends parallel to the central axis 315 along the inner surface 312 of the shell base 306. As such, the inner surface 312 and the outer surface 341 are shaped to complement each other. In another alternative embodiment, the intermediate component 308 may include a longitudinal channel along the outer surface 341 of the inner collar 340, and the inner surface 312 of the shell base 306 may include a longitudinal ridge or protrusion that is received within the longitudinal channel. Alternatively, the longitudinal ridges may be substituted with posts or bosses that slide within the longitudinal channels. In such embodiments, the longitudinal channels may have non-linear shapes.

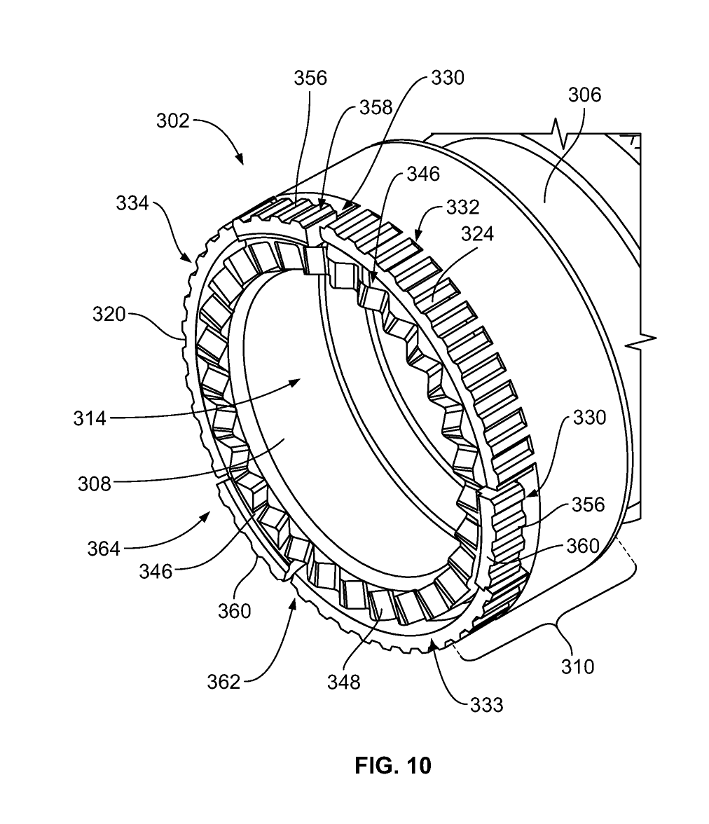

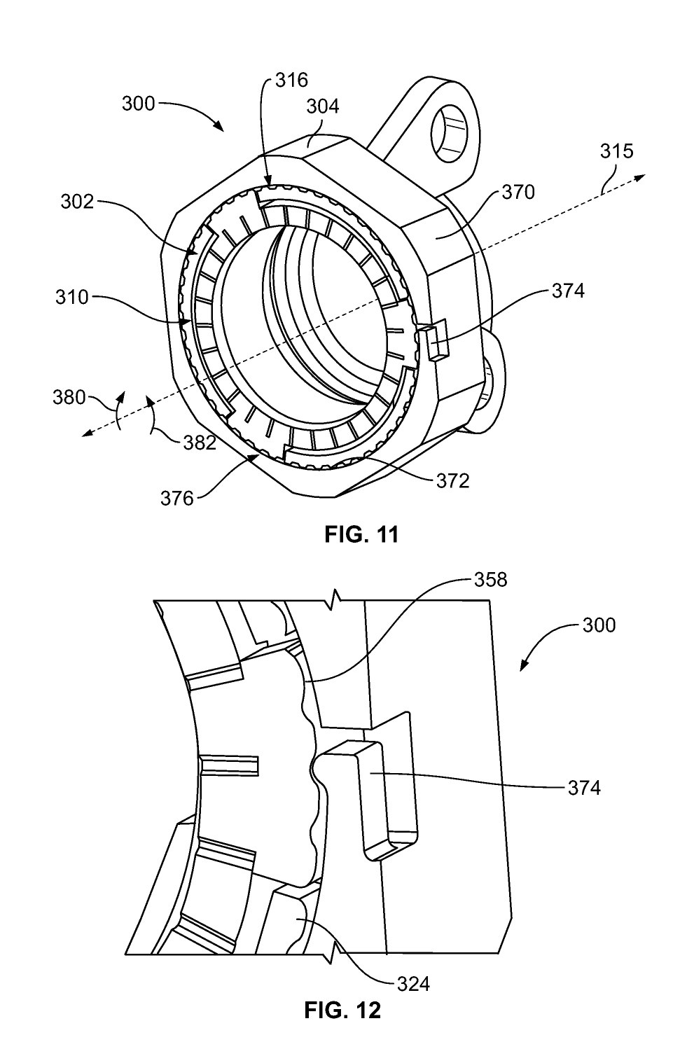

FIG. 10 is an enlarged perspective view of the multi-piece connector shell 302 after the intermediate component 308 has been positioned within the passage 314 of the shell base 306. When the intermediate component 308 is inserted into the passage 314, each of the teeth sections 332-334 of the shell base 306 slides over a portion of the forward section 342 such that each of the teeth sections 332-334 interfaces with a portion of the outer surface 354.

When combined, the intermediate component 308 and the shell base 306 form the end section 310. The end section 310 may be similar to the end section 122 (FIG. 1). For example, the radial extensions 356 are positioned within corresponding open-sided slots 330. The leading edge 320 of the shell base 306 and the edge faces 360 of the radial extensions 356 align with one another to form a substantially continuous or leading edge 362 of the connector shell 302 (or the end section 310). Likewise, the section teeth 358 are exposed to the exterior of the connector shell 302 and align with the radial teeth 324 so that a substantially continuous series of radial teeth 324, 358 is formed. Also shown, the axial teeth 348 are positioned adjacent to the radial teeth 324, 358. A front end 364 of the connector shell 302 includes the leading edge 362 and the leading edge 346.

FIG. 11 is a perspective sectional view of the electrical connector 300, and FIG. 12 is an enlarged view of the electrical connector 300. With respect to FIG. 11, the coupling nut 304 may be similar or identical to the coupling nut 104 (FIG. 1). For example, the coupling nut 304 includes a sleeve wall 370 having an inner surface 372 and a spring arm 374. When operably engaged, the coupling nut 304 is mounted to the end section 310 of the multi-piece connector shell 302 and is rotatable about the central axis 315. An interface 376 is defined between the outer surface 316 of the connector shell 302 and the inner surface 372 of the coupling nut 304.

As shown in FIG. 12, the spring arm 374 may be slidably engaged to the radial teeth 324, 358 in a ratchet-like manner. The spring arm 374 and the radial teeth 324, 358 may be shaped relative to one another to impede rotation in a first direction 380 (FIG. 11), but permit rotation in the second direction 382 (FIG. 11). More specifically, as the coupling nut 304 is rotated, the spring arm 374 engages the section teeth 358 of the intermediate component 308 and the radial teeth 324 of the shell base 306. Accordingly, the multi-piece connector shell 302 and the coupling nut 304 may interact in a similar or identical manner as the connector shell 102 (FIG. 1) and the coupling nut 104 (FIG. 1).

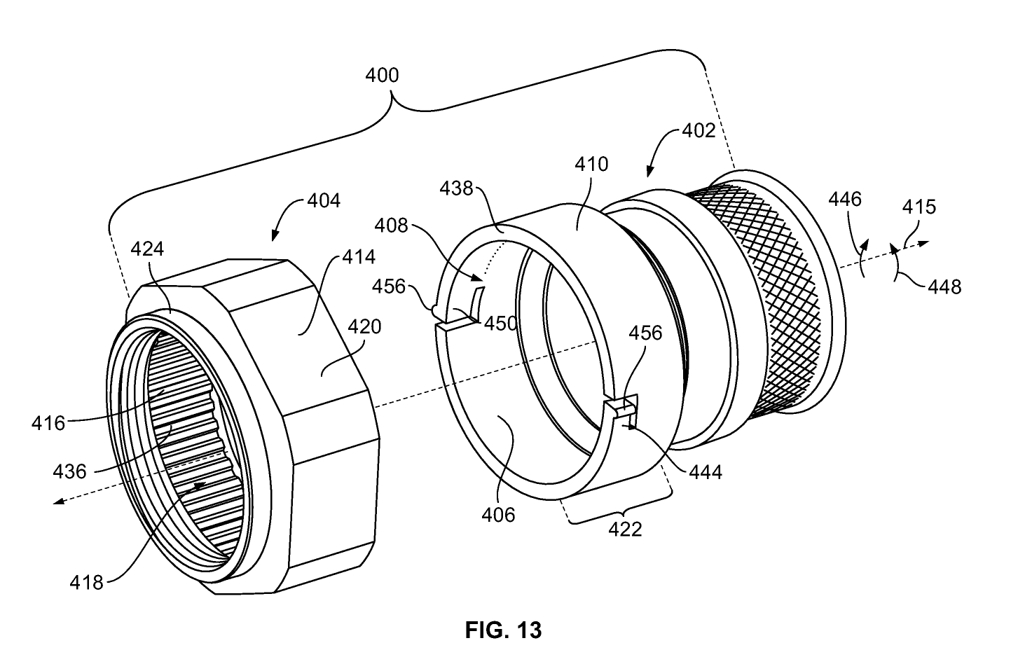

FIG. 13 is an exploded view of an electrical connector 400 in accordance with an embodiment. The electrical connector 400 may include similar features as the electrical connector 100 (FIG. 1) and the electrical connector 300 (FIG. 11). For example, the electrical connector 400 has a connector shell 402 and a coupling nut 404 that is configured to rotatably engage the connector shell 402. In FIG. 13, the coupling nut 404 is spaced apart from the connector shell 402, but poised for engaging the connector shell 402.

The coupling nut 404 includes a sleeve wall 414 that has an inner surface 416 defining a coupling cavity 418. The sleeve wall 414 also has an outer surface 420 that defines an exterior of the coupling nut 404. The coupling cavity 418 is sized and shaped to receive an end section 422 of the connector shell 402. The coupling nut 404 also includes a front mating section 424 that is coupled to the sleeve wall 414 that is similar or identical to the front mating section 124 (FIG. 1).

The end section 422 of the connector shell 402 includes an inner surface 406 that defines a passage 408. Optionally, the electrical connector 400 may include a dielectric insert (not shown) that is positioned in the passage 408 of the connector shell 402. The dielectric insert may be similar or identical to the dielectric insert 130 (FIG. 1). The dielectric insert may support electrical contacts, such as the electrical contacts 132 (FIG. 1).

The end section 422 includes a leading edge 438 that is configured to engage the coupling nut 404 within the coupling cavity 418. More specifically, the leading edge 438 may engage a rearward-facing surface (not shown) of the front mating section 424. The end section 422 also includes spring arms 444, 450. The spring arms 444, 450 may be similar to the spring arm 144 (FIG. 2), but the spring arms 444, 450 are configured to face radially outward and engage the inner surface 406 of the coupling nut 404. More specifically, the spring arms 444, 450 are configured to engage the radial teeth 436 in a ratchet-like manner.

When operably engaged, the coupling nut 404 is mounted to the end section 422 of the connector shell 402 and is rotatable about a central axis 415. An interface (not shown) would be defined between an outer surface 410 of the connector shell 402 and the inner surface 406 of the coupling nut 404. The spring arms 444, 450 have contoured heads 456 that clear an exterior boundary defined by the outer surface 410 to engage the radial teeth 436. The contoured heads 456 and the radial teeth 436 are shaped such that, when engaged in a ratchet-like manner, the spring arms 444, 450 and the radial teeth 436 may impede rotation in a first direction 446 but permit rotation in the second direction 448.

Accordingly, an electrical connector 400 is provided. The electrical connector 400 may include electrical contacts (not shown), such as the electrical contacts 132 (FIG. 1). The electrical connector 400 may also include a connector shell 402 having a passage 408 therethrough. The electrical contacts may be positioned within the passage 408. A central axis 415 extends through a center of the passage 408. The connector shell 402 has an end section 422 that is shaped to include a spring arm 444. The electrical connector 400 also includes a coupling nut 404 that is rotatably mounted to the end section 422. The coupling nut 404 has a sleeve wall 414 that surrounds and interfaces with the end section 422. The sleeve wall 414 is shaped to include a series of radial teeth 436 that are disposed circumferentially around the central axis 415. The radial teeth 436 face radially toward the central axis 415. When the coupling nut 404 and the connector shell 402 are operably coupled, the spring arm 444 slidably engages the radial teeth 436 in a ratchet-like manner as the coupling nut 404 is rotated about the central axis 415. The spring arm 444 and the radial teeth 436 may impede rotation in a first direction 446 and permit rotation in an opposite second direction 448. Optionally, the electrical connector 400 may be devoid of discrete elements that are disposed between the coupling nut 404 and the connector shell 402, except for elastic seal members (e.g., o-rings).

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The patentable scope should, therefore, be determined with reference to the appended claims, along with the full scope of equivalents to which such claims are entitled.

As used in the description, the phrase “in an exemplary embodiment” and the like means that the described embodiment is just one example. The phrase is not intended to limit the inventive subject matter to that embodiment. Other embodiments of the inventive subject matter may not include the recited feature or structure. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112(f), unless and until such claim limitations expressly use the phrase “means for” followed by a statement of function void of further structure.

1. An electrical connector comprising:
a connector shell having a passage therethrough configured to support an electrical pathway, the connector shell including an end section, wherein a central axis extends through a center of the passage; and
a coupling nut mounted to the end section of the connector shell and having a sleeve wall that surrounds and interfaces with the end section, the coupling nut being rotatable about the central axis;
wherein the sleeve wall of the coupling nut or the connector shell has an inner surface, an outer surface, and a wall opening extending through the inner and outer surfaces, the wall opening defining a spring arm such that the spring arm is integrally formed with the sleeve wall or the connector shell, wherein the other of the sleeve wall or the connector shell includes a series of radial teeth that are disposed circumferentially around the central axis, the spring arm slidably engaging the radial teeth in a ratchet-like manner as the coupling nut is rotated about the central axis, the spring arm and the radial teeth impeding rotation in a first direction about the central axis and permitting rotation in an opposite second direction about the central axis.

2. The electrical connector of claim 1, wherein the electrical connector is devoid of discrete elements that are disposed between the coupling nut and the connector shell.

3. The electrical connector of claim 1, wherein the spring arm is a first spring arm, the one of the sleeve wall and the connector shell also including a second spring arm that engages the radial teeth in a ratchet-like manner as the coupling nut is rotated about the central axis.

4. The electrical connector of claim 1, wherein the end section of the connector shell has a leading edge that defines an opening to the passage, the leading edge having an outer diameter, the coupling nut having a front mating section that includes an inner diameter that is less than the outer diameter.

5. The electrical connector of claim 1, wherein the connector shell includes a shell base having a portion of the end section and an intermediate component coupled to the shell base, the shell base having a leading edge that is shaped to include open-sided slots, wherein the intermediate component includes radial extensions disposed within the open-sided slots, the end section including a portion of the radial teeth and the radial extensions including a portion of the radial teeth.

6. The electrical connector of claim 6, wherein the intermediate component includes axial teeth that project along the central axis and are configured to engage the mating connector.

7. An electrical connector comprising:
a connector shell having a passage therethrough configured to support an electrical pathway, wherein a central axis extends through a center of the passage, the connector shell having an end section that includes a series of radial teeth disposed circumferentially around the central axis, the radial teeth facing radially away from the central axis; and
a coupling nut that is rotatably mounted to the end section of the connector shell, the coupling nut having a sleeve wall that surrounds and interfaces with the end section of the connector shell, the sleeve wall has a wall opening that defines a spring arm such that the spring arm is integrally formed with the sleeve wall, the spring arm slidably engaging the radial teeth in a ratchet-like manner as the coupling nut is rotated about the central axis, the spring arm and the radial teeth impeding rotation in a first direction and permitting rotation in an opposite second direction.

8. The electrical connector of claim 7, wherein the electrical connector is devoid of discrete elements that are disposed between the coupling nut and the connector shell.

9. The electrical connector of claim 7, wherein the spring arm extends lengthwise in a direction that is parallel to the central axis.

10. The electrical connector of claim 7, wherein the sleeve wall includes a wall opening, the spring arm being positioned within the wall opening and permitted to move between first and second positions as the spring arm slidably engages the radial teeth, the spring arm moving within the wall opening when moving between the first and second positions.

11. The electrical connector of claim 7, wherein the spring arm has an outer surface and moves between first and second positions as the spring arm slidably engages the radial teeth, the coupling nut defining an exterior boundary, wherein the outer surface of the spring arm does not clear the exterior boundary.

12. The electrical connector of claim 7, wherein the sleeve wall has an outer surface that represents an exterior of the coupling nut and an inner surface that interfaces with the end section of the connector shell, the sleeve wall having a wall opening that extends through the outer surface and through the inner surface, the sleeve wall being positioned within the wall opening.

13. The electrical connector of claim 7, wherein the connector shell includes a shell base having a portion of the end section and an intermediate component coupled to the shell base, the shell base having a leading edge that is shaped to include open-sided slots, wherein the intermediate component includes radial extensions disposed within the open-sided slots, the end section including a portion of the radial teeth and the radial extensions including a portion of the radial teeth.

14. The electrical connector of claim 13, wherein the intermediate component includes axial teeth that face in a direction that is parallel to the central axis.

15-19. (canceled)

20. The electrical connector of claim 7, wherein the wall opening extends entirely through the sleeve wall.

21. The electrical connector of claim 7, wherein the spring arm includes a contoured head that is configured to engage the radial teeth, the contoured head and the radial teeth are shaped to provide a mating resistance when rotated in the first direction that is more than a mating resistance when rotated in the second direction.

22. The electrical connector of claim 7, wherein the sleeve wall has an exterior boundary that is defined by an outer surface of the sleeve wall, the spring arm being positioned within the wall opening such that an outer surface of the spring arm is disposed a depth from the exterior boundary within the wall opening.

23. The electrical connector of claim 1, wherein the spring arm includes a contoured head that is configured to engage the radial teeth, the contoured head and the radial teeth are shaped to provide a mating resistance when rotated in the first direction that is more than a mating resistance when rotated in the second direction.

24. The electrical connector of claim 1, wherein the sleeve wall includes the spring arm.

25. The electrical connector of claim 1, wherein the connector shell includes the spring arm.
